(19) United States
(12) Patent Application Publication
(10) Pub. No.: US 2015/0026184 A1
(43) Pub. Date: Jan. 22, 2015

(54) METHODS AND SYSTEMS FOR CONTENT MANAGEMENT

(71) Applicant: Catherine Ossikine, Newton, MA (US)

(72) Inventor: Catherine Ossikine, Newton, MA (US)

(21) Appl. No.: 14/334,776

(22) Filed: Jul. 18, 2014

Related U.S. Application Data
(60) Provisional application No. 61/847,601, filed on Jul. 18, 2013.

(51) Int. Cl. G06F 17/30; G09B 5/00

(52) U.S. Cl. CPC G06F 17/30705; G06F 17/30011; G09B 5/00
USPC 707/738; 434/322

(57) ABSTRACT

Methods and systems for content creation and management. Electronic documents are retrieved and organized into one or more items of subject-specific content. At least one concept is automatically associated with each item of subject-specific content. The items of subject-specific concept can then be organized automatically according to their associated concepts.

### CROSS-REFERENCE TO RELATED APPLICATIONS

The present application claims the benefit of co-pending U.S. provisional application no. 61/847,601, filed on Jul. 18, 2013, the entire disclosure of which is incorporated by reference as if set forth in its entirety herein.

### FIELD OF THE INVENTION

The invention relates generally to methods and systems for content creation and management, and more specifically to an educational platform that ingests content, organizes it o educational units, and then organizes those units into a library.

### BACKGROUND OF THE INVENTION

Online and distance learning has become increasingly common with the ubiquity of network connected computing devices, especially with the improved quality of online video and audio presentation and the availability of various educational content online.

While there are services that serve as repositories of curricula from various contributing educators, such repositories are limited in that the content varies greatly in presentation, format, and approach. Motivated educators who are looking to inspire their students with supplemental instructional materials often spend a great deal of time and resources searching for and retrieving acceptable content from these ever-growing repositories.

Accordingly, there is a need for systems and methods that can make educational content more readily available to interested users.

### SUMMARY OF THE INVENTION

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Various embodiments of the invention stem from an observation that it is advantageous to facilitate online learning by providing an educational platform with a library of carefully indexed and categorized units of learning—INFOBITS, i.e., units of educational content. Like small pieces of a puzzle that create a complete picture, INFOBITS can piece together a structured framework of knowledge. Starting with the premise that all educational materials can be assigned specific attributes, various embodiments, individually or collectively, create a “knowledge map” of linked INFOBITS to form a system for the delivery of educational content. Such a system facilitates comprehension by grouping related information and ensuring that completed courses are not repeated but that appropriate educational progress occurs.

INFOBITS can be organized to provide a comprehensive source for individuals to find and access high quality and relevant educational materials, indexed and pre-filtered through a search system. In one embodiment, that search system performs a search against a pre-filtered list of previously categorized and indexed topics.

In addition, INFOBITS can be used to provide a platform where a student can complete an entire course. Embodiments of the invention parse through and classify large volumes of information, bring carefully organized educational content to users.

In one aspect, the present invention relates to a method for content management. The method includes automatically organizing an electronic document into at least one item of subject-specific content. A concept associated with the at least one item of subject-specific content is automatically determined. The at least one item of subject-specific content is organized based on the at least one determined concept for the at least one item of subject-specific content. The electronic documents may be retrieved because they match at least one pre-specified keyword, or they may be retrieved from a pre-specified list of documents.

In one embodiment, the method includes automatically determining the difficulty level of the at least one item of subject-specific content by analyzing the occurrence of words in the at least one item of subject-specific content. In one embodiment, automatically determining the concept for the at least one item of subject-specific content includes comparing keyword statistics for the at least one item against pre-existing statistics for keywords derived from a control set of documents. These keywords derived from a control set of documents may be organized, for example, in a concept map. In one embodiment, the method includes determining at least one related-concept keyword for the at least one item of subject-specific content. In one embodiment, the method also includes the retrieval of the electronic document through a network connection. In one embodiment, the method further includes providing at least one item of subject-specific content to a user.

In another aspect, the present invention relates to a system for content management. The system includes a non-volatile memory; and a processor configured to retrieve the at least one electronic document and store it in the non-volatile memory, automatically organize the retrieved document into at least on item of subject-specific content, automatically determine a concept associated with the at least one item of subject-specific content; and organize the at least one item of subject-specific content based on the at least one determined concept for the at least one item of subject-specific content. The electronic documents can be retrieved from a pre-specified list of documents stored in the non-volatile memory, or match at least one pre-specified keyword stored in the non-volatile memory.

In one embodiment, the processor is configured to automatically determine the difficulty level of the at least one item of subject-specific content by analyzing the occurrence of words in the at least one item of subject-specific content. In one embodiment, the processor is configured to automatically determine the concept for the at least one item of subject-specific content by comparing keyword statistics for the at least one item against pre-existing statistics for keywords derived from a control set of documents. Those keywords may be organized, for example. in a concept map. In one embodiment, the processor is configured to determine at least one related-concept keyword for the at least one item of subject-specific content. In one embodiment, the system also includes a network interface for the transmission and retrieval of at least one electronic document. In one embodiment, the system also includes an interface to deliver at least one item of subject-specific content to a user.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF DRAWINGS

Non-limiting and non-exhaustive embodiments are described with reference to the following FIGS. in which:

FIGS. 1 and 2 are diagrams of methods for determining the concepts and difficulty of a document according to some embodiments of the invention;

FIG. 3A is a block diagram of an embodiment for segmenting larger documents into subject-specific INFOBITS;

FIG. 3B shows how documents can be grouped into INFOBITS according to statistical analysis of their contents;

FIG. 4 is a block diagram of an embodiment for automatically determining the concepts associated with an INFOBIT;

FIG. 5 is an example of identifying related concepts according to one embodiment;

FIG. 6 is a block diagram of a method for automatically determining a difficulty level of a document according to one embodiment of the invention;

FIG. 7 is a block diagram of an embodiment for determining a set of difficulty levels;

FIGS. 8, 9, and 10 are diagrams of methods for organizing and storing content items by concept in accord with various embodiments of the invention;

FIG. 11 depicts how concepts in one field can be extrapolated to other areas;

FIG. 12 is a diagram of a method for organizing educational data for concept-based online learning according to one embodiment of the invention;

FIG. 13 is a diagram of a method for selecting the most appropriate pedagogical information for a user according to one embodiment of the invention;

FIGS. 14A-B are examples of determining missing knowledge according to various embodiments of the invention;

FIG. 15 depicts how the pedagogical value of a particular piece of content may be determined;

FIG. 16 depicts how the results of a web search can be ranked by concept in accord with one embodiment of the invention; and

FIG. 17 illustrates how the results of a web search can be ranked by quality and number of views in accord with another embodiment of the present invention.

In the drawings, like reference characters generally refer to corresponding parts throughout the different views. The drawings are not necessarily to scale, emphasis instead being placed on the principles and concepts of operation.

### DETAILED DESCRIPTION

It is advantageous to define several terms before describing the invention. It should be appreciated that the following terms are used throughout this application.

### Definitions

For the purposes of the present invention, the term “users” refers to people searching for online educational resources. They can be students looking for classes, courses, or supplemental information, or educators, such as parents or teachers.

For the purposes of the present invention, the term “state of knowledge” refers to an assumption of what a user knows and to what extent.

For the purposes of the present invention, the terms “educational materials” or “educational content” refer to any type of educational content found on the internet and in any form. The focus is primarily on materials (i.e., videos and text) that can allow for online learning of an entire course and enhance the existing classroom learning experience.

For the purposes of the present invention, the term “INFOBIT” refers to a unit of educational content. An INFOBIT can be any piece of information in any form, such as an electronic document (e.g. lecture notes, presentations, book chapters. videos, online references, or portions thereof). Examples of particular INFOBITS include a textbook, a scientific publication, a video of a scientific experiment, etc. An INFOBIT can be small, such as a diagram from a textbook, or it can be sizeable, such as an entire textbook. INFOBITS can contain other INFOBITS.

For the purposes of the present invention, the term “concept” refers to a specific topic or subject associated with an INFOBIT. Exemplary concepts include “multiplication” or “stresses in pronunciation in Russian language.”

For the purposes of the present invention, the term “concept map” refers to a representation of the relationships between concepts. It is frequently used as a graphical tool for organizing and representing knowledge.

For the purposes of the present invention, the term “statistics” refers to the collection and analysis of data using techniques known to one of ordinary skill, sometimes for the purpose of drawing inferences from the analyzed data. Particular examples of statistics used to analyze keywords include: (1) comparing singular occurrences of one or more keywords against various lists of keywords associated with certain subjects to infer the subject of the document containing the keywords; the greater the number of words appearing from a particular category, the more likely it will be that the document will be assigned to the category, (2) comparing multiple occurrences of one or more keywords against various lists of keywords associated with certain subjects to infer the subject of the document containing the keywords; this is similar to technique (1), but multiple occurrences of a keyword may be weighted more heavily that a singular appearance of a keyword. (3) considering all of the words in a document by assigning a probability of occurrence of each word in a document of a specific category based on that word's distribution in other documents of that category as well as in all other categories, and multiplying the number of appearances of that word by the probability of occurrence to determine the final category of the document. Technique (3) can also be used to determine the difficulty level of a document by weighing the appearances of the word by their probability of occurrence in documents of varying difficulty levels.

For the purposes of the present invention, the term “semantic analysis” refers to the analysis of syntactic structures and writings using techniques known to one of ordinary skill. Particular examples of semantic analysis techniques used to analyze writings include: (1) looking for specific “identifier” keywords, such as “. . . is”, “would be”, etc., occurring in particular locations in a document, such as in one of the first two paragraphs, in the beginning of the sentence, etc., to identify the following language as a concept for matching against a concept map, and (2) parsing metadata associated with a writing, such as its title or its URL (e.g., . . . edu\category\category\subject, where words found in “category” or “subject” match entries in a concept map.

### Description

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are the means used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions that could be embodied in software, firmware or hardware. and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions. and each coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

In brief overview, various embodiments of the invention provide an educational platform with a library of indexed, categorized and linked units of learning, i.e., INFOBITS. These embodiments are also capable of performing one or more of the following steps: crawling the World Wide Web (WWW) for educational content; approving the crawled content sources; organizing individual documents into INFOBITS; and creating a knowledge map and providing access to the knowledge map to users. In addition, various embodiments of the invention perform tasks in connection with providing an automated educational platform.

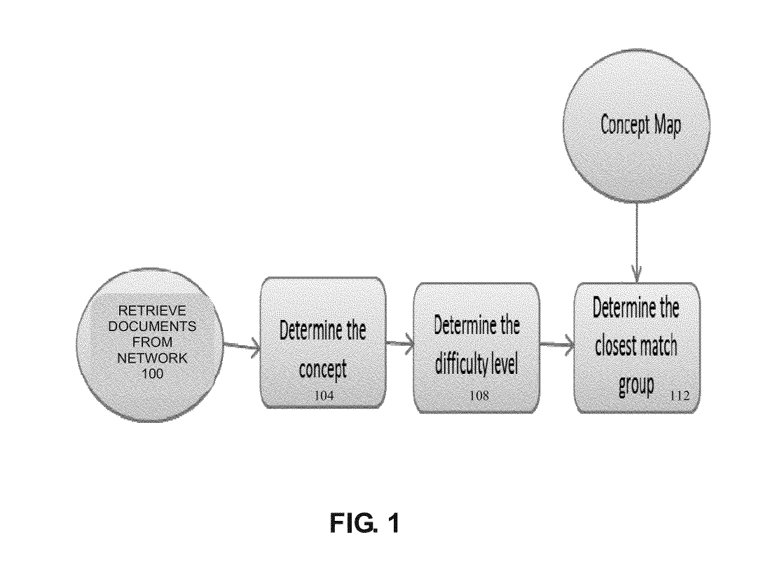

FIG. 1 presents an example of an embodiment that determines the subject matter or concepts described in particular items of content, as well as their difficulty level. The content may then be grouped according to their concepts and difficulty levels.

Embodiments of the present invention traverse network-connected resources to collect electronic documents (Step 100). The collection of electronic documents (Step 100) is conducted in accord with various techniques known to the prior art. Such techniques include, but are not limited to, the use of “spidering” software.

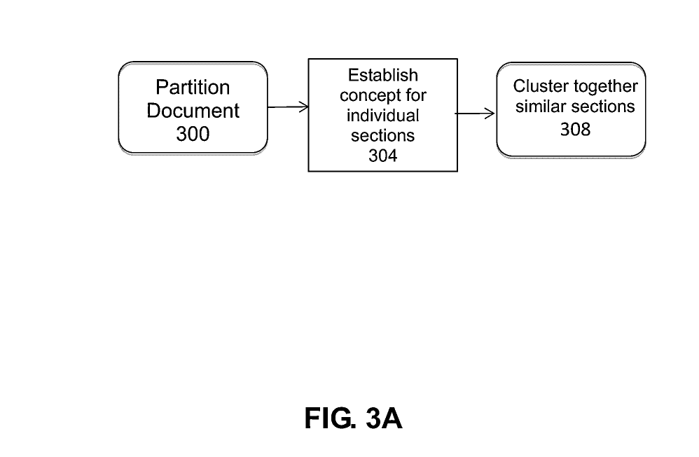

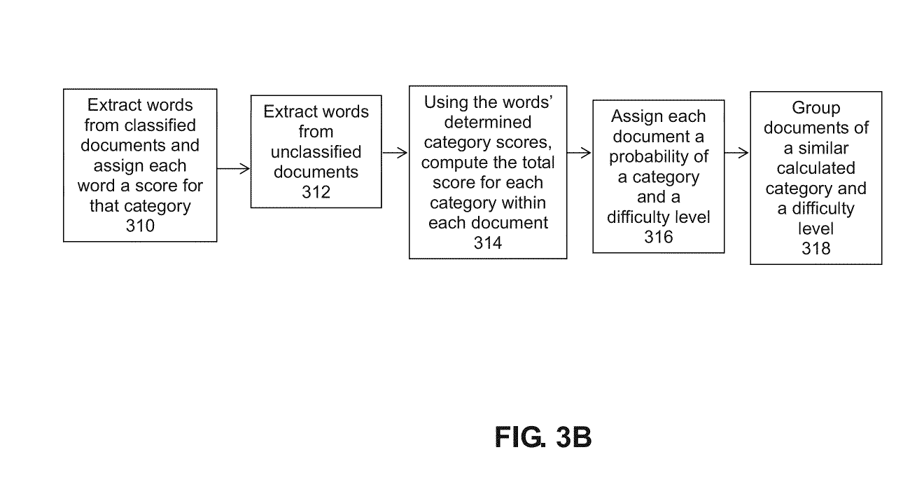

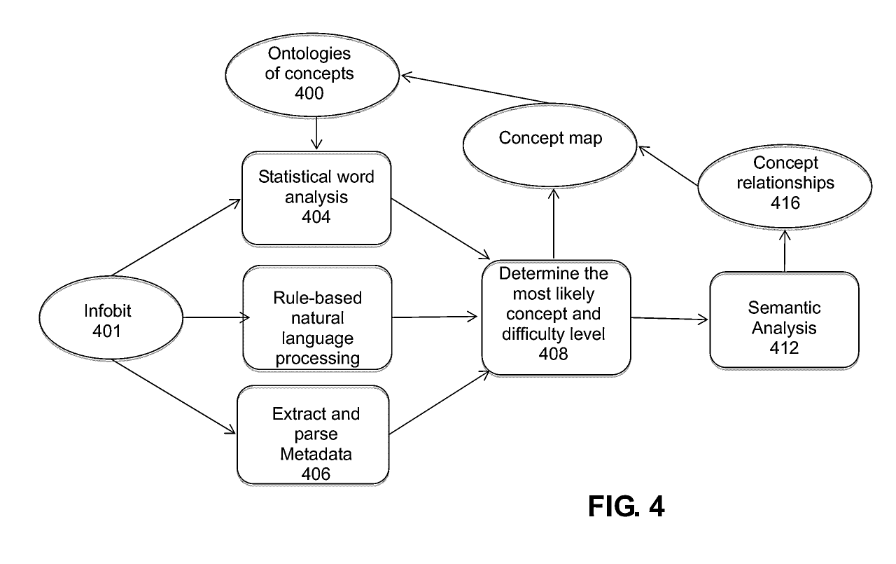

Next the document's subject area is determined (Step 104), as discussed below in connection with FIG. 4. If the document is determined to address multiple subject areas, it can be subsequently organized into multiple INFOBITS, i.e., individual items of educational content having a consistent concept or theme, as discussed below in connection with FIG. 3, and the subject area and difficulty of each INFOBIT can be analyzed individually.

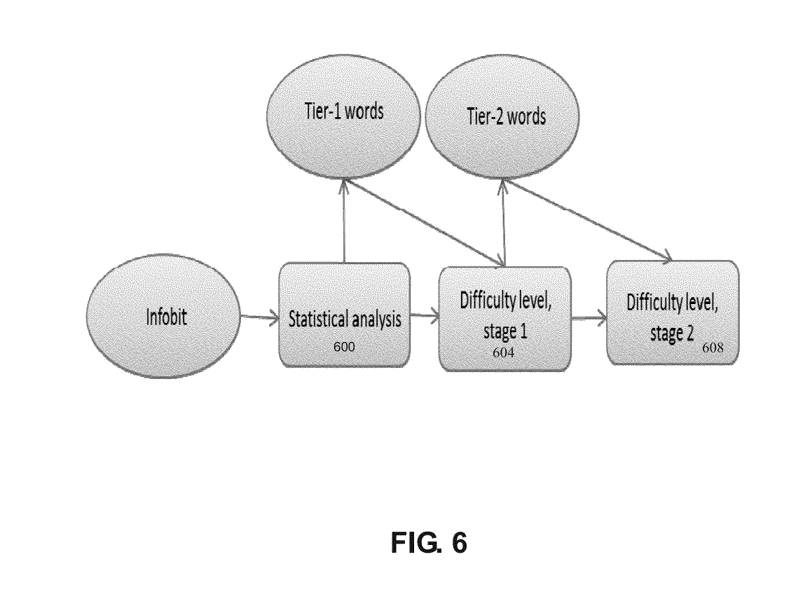

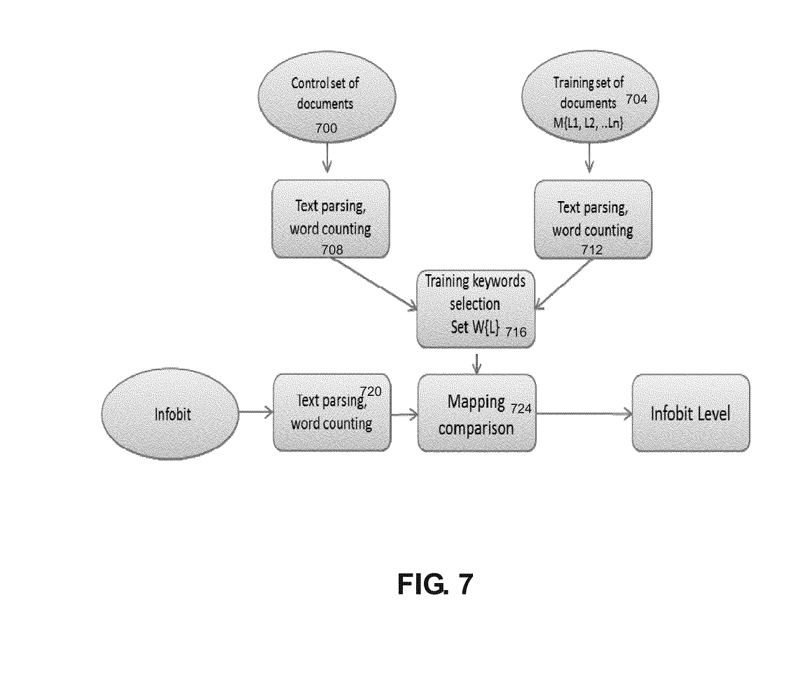

The document's difficulty is determined (Step 108), as discussed below in connection with FIGS. 6 and 7. As mentioned above, the difficulty of individual portions of the document can be determined when such analysis is appropriate.

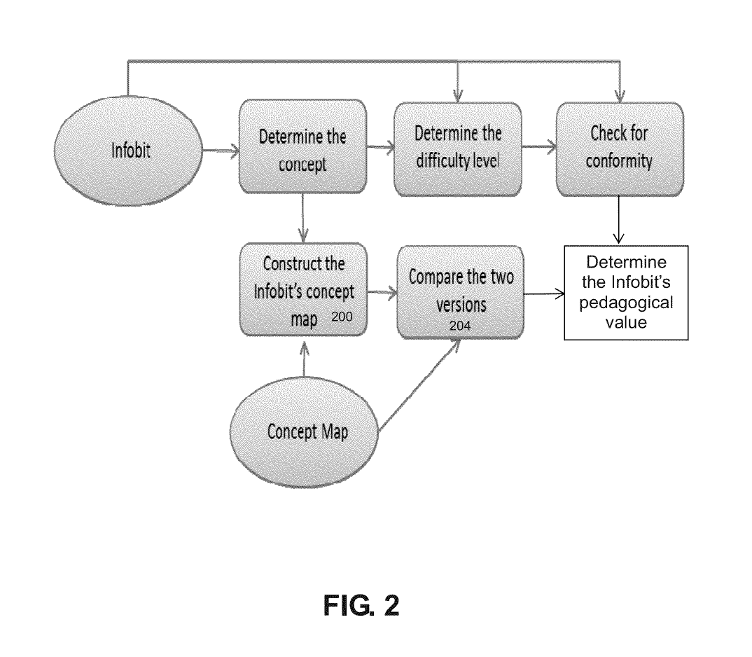

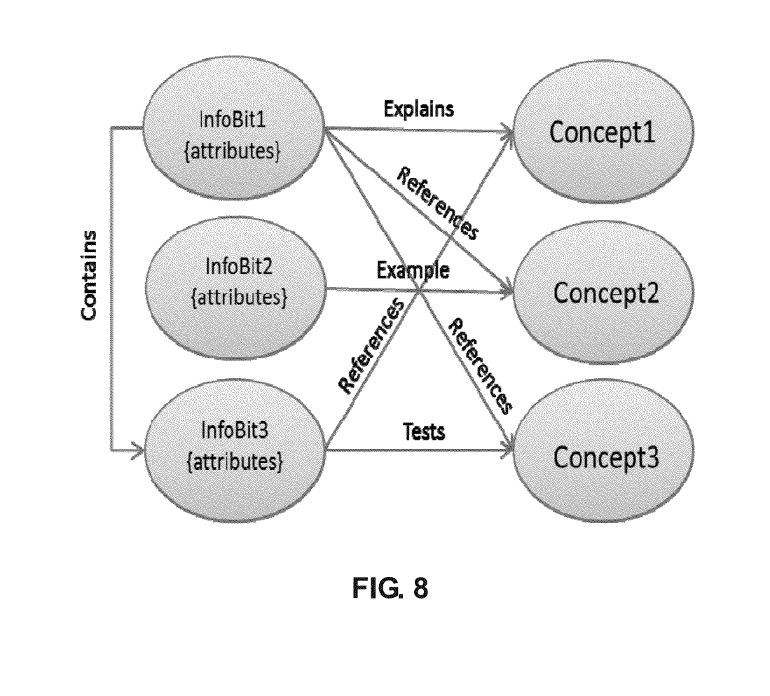

With reference to FIG. 2, a concept map can be constructed for the document based on concept keywords and their relationships within the document (Step 200), as discussed below in connection with FIGS. 8-11. The document's concept map can be compared against a localized portion of a global concept map derived from a large set of documents (Step 204). The more conforming and compact the document concept map, i.e., the concepts should be closely related to each other, then the higher the pedagogical value of the content.

The pedagogical value of the content may also be inferred by comparing the difficulty of the concepts appearing in the content against the difficulty level of the main concept of the content. If the difficulty level of the main concept is significantly lower than the difficulty of other concepts present in that content, then the pedagogical value of that document is lower—i.e., the main concept should be more difficult than and build on the ancillary concepts contained in the content. The overall target-age level of the document and the main concept may also be determined using natural language processing methods and compared to the complexity level of the other concepts present in that content for verification purposes.

FIG. 3A shows a block diagram of one embodiment for segmenting retrieved documents into subject-specific INFOBITS (Step 304). The embodiment partitions the original document into sections according to formatting (Step 300); performs independent statistical keyword analysis of each section to determine a concept associated with the INFOBIT (Step 304); and groups related sections together according to clustering rules (Step 308).

Partitioning the original document into sections according to formatting (Step 300) can utilize any existing formatting of the document, such as titles, paragraphs, line breaks, any html tags or other boundary detection mechanisms.

The sections can be organized (Step 308) by performing semantic analysis and searching the sections for any cue phrases such as “furthermore,” “in conclusion,” etc. and group the sections based on the cue phrases. Sections can also be organized by performing statistical analysis on each section and evaluate keyword distributions. Sections may also be organized by performing similarity computation on sections; sections that have a similar keyword distribution pattern are clustered together. In addition, if the exact subject matter of each subsection can be established with a high certainty (using the methods described below) and there is lexical cohesion between them, then the sections that follow each other are grouped together into one INFOBIT.

While embodiments of the present invention can partition a single item of content into multiple INFOBITS, it is also possible to aggregate multiple items of content into a single INFOBIT when, for example, those items of content share the same primary concepts and similar difficulty levels. With reference to FIG. 3B, the process statistically analyses all the words in the documents and groups the documents according to the result of the analysis. An appropriate clustering-based model may be utilized to determine the document's group.

The grouping process begins by parsing documents known categories and assigning scores to each word in each document for each category (Step 310). The documents in question are parsed and their words are counted (Step 312) and those words' scores are used to assign the documents' final category score (Step 314). The category of the documents in question is determined based on their determined probabilities of being in a particular category/level (Step 316). The more words that the documents have in common, the more likely they are to be grouped together (Step 318). Also the level of overlap can be used to establish a similarity threshold, i.e., the lowest percentage of words in both documents that need to match for the two documents to be considered in the same group.

### Content Concepts

With reference to FIG. 4, embodiments of the present invention can automatically determine the subject area and concepts described in a section of a document obtained through the partitioning process described above, the subject area and concepts described in an INFOBIT (which can itself be an aggregation of one or more document sections or other content), or a document as a whole. With a list of subject areas and concepts, these embodiments cam automatically construct a concept dependency map for the analyzed content, such as a collection of INFOBITS. For example, an embodiment can collect statistics concerning subject keywords used in an INFOBIT and compare those statistics to a pre-existing mapping of keywords stored in a database.

The concept identification process begins with the assembling of a database of concept keywords for each general subject area. For example, the database can be built from such sources such as ontologies, encyclopedias, or keyword or key-phrase indices from textbooks, articles, or other sources. Once the keywords are gathered, they can be used to assemble a list of concepts for each subject area based on the keywords (Step 400). Keywords and concepts may not necessarily have a one-to-one mapping. Alternately, a set of pre-classified documents can be analyzed for frequently-occurring keywords and those keywords can automatically be associated with the classification categories associated with those documents.

A given section of interest (or INFOBIT, etc., 401) can then be evaluated for use of the concept keywords present in the database (Step 404). Having determined the statistics concerning the appearance of concept keywords, the subject area of the content can be inferred from the frequency of occurrence of particular keywords. The inferred subject can be verified by comparing it against the title, subtitle, and other information found in descriptive source metadata (406, for example: website name, website URL, literary source, author name, etc.) of the section (INFOBIT, etc.) (Step 408). In some instances, a website URL may contain keywords that correspond to the concept described in the related document or possible related concepts and/or categories.

The subject-area specific keywords in the section (INFOBIT, etc.) can also be used to construct a concept map for the content under analysis. That process begins by analyzing statistics and semantics concerning the use of concept keywords in the content (Step 412). Using hard-coded rules based on certain phrases (such as “explains”, and “using”) the relationship between concepts and their pre-requisites can be determined and the result is a dependency and relationship map among the identified concepts (416).

For example: the most frequently occurring keyword in the content is usually related to the main concept of the content, and other frequently used keywords in the concept are likely to be related to the main concept as pre-requisites. These relationships are stored in a database and may be weighted based on their frequency of occurrence in the content 401.

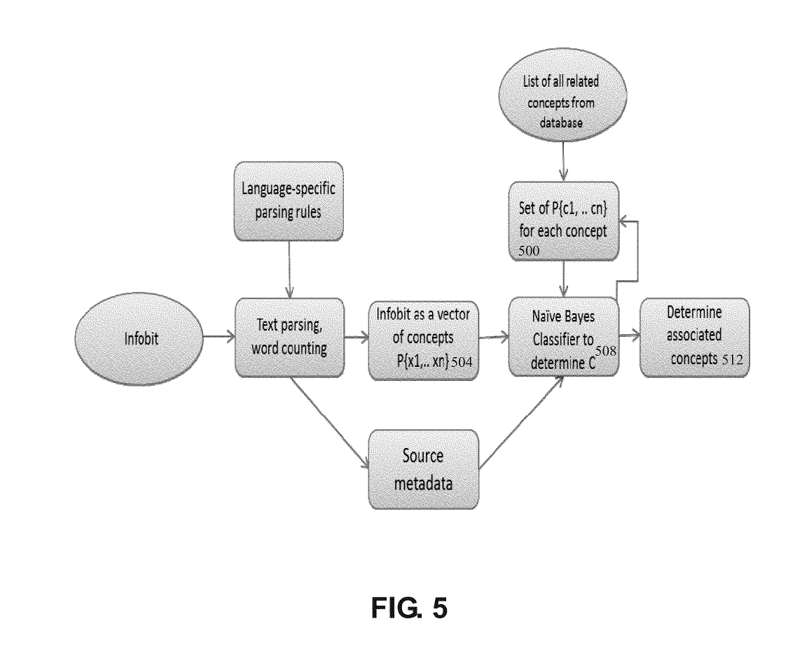

In addition to determining a primary concept associated with a piece of content, embodiments of the present invention can identify additional concepts relevant to the primary concept. FIG. 5 shows one embodiment for identifying a related set of concepts {c1, c2, . . . cn}. Each concept stored in the database is associated with a list of related concepts, so that for each concept there is a concept vector P{c1, c2, c3 . . . cn|C} of concepts 500 related to concept C. Thus, in this embodiment, a piece of content can be represented as a vector of concepts {x1, x2, x3, . . . xn} 504. Using a Naïve Bayes Classifier or the process described above, determine the most likely main concept C for the content (Step 508). Adjust the probability P(c) in the Classifier using information gathered from the title, subtitle, and other source metadata of the content.

After the primary concept for the content is established, the embodiments average the determined concept vector for the content with the initial set P{c1, c2, c3 . . . cn} to train the system and perform statistical analysis on the remaining concept vector for the concept {x1, x2, x3 . . . xn}-C to determine additional frequently referenced concepts (Step 512). In another embodiment, hard-coded rules that associate certain keywords (such as “explains”, and “using”), are used to determine pre-requisite concepts for the content and compare the resulting list to the list of pre-requisite concepts for C from the internal database.

### Content Difficulty

Embodiments o the invention can also include functionality to automatically determine the difficulty level of an item of content (INFOBIT, etc.). One embodiment determines the difficulty level by statistically analyzing word distributions across multiple documents and then determining the difficulty of a particular document by determining how often it uses infrequently occurring words, as the difficulty of a word is often related (in some applications, inversely proportional) to its frequency.

FIG. 6 illustrates one embodiment primarily intended for use analyzing documents used for language learning. This embodiment determines the difficulty of the content in stages, i.e., it first determines an approximation of the difficulty level and later refines it.

The process begins by determine the statistical frequency of words across a large sample of documents (Step 600). The “Tier-1,” i.e., approximate, difficulty of a word is defined to be inversely related to its frequency of occurrence: the less often the word occurs, the higher its Tier-1 difficulty.

With this background information in hand, the approximate difficulty level of a piece of content (document, document section, INFOBIT, etc.) is computed by determining the occurrence of words in that content that have a level of Tier-1 difficulty above a predefined threshold (Step 604). The analysis is repeatedly performed on a larger set of documents to determine the Tier-1 difficulty level of the larger set.

The analysis can then be refined to a more specific level of difficulty by defining the Tier-2 difficulty of a word to be proportional to the lowest Tier-1 difficulty level of documents in which it commonly occurs, relative to its frequency of occurrence in documents as a whole. Then, the Tier-2 difficulty of a document can be defined to be proportional to the frequency of occurrence of words of high Tier-2 difficulty words contained in the document. In short, the Tier-2 difficulty of the document is high if it contains difficult words.

FIG. 7 presents a block diagram of an embodiment for determining a set of difficulty levels. In overview, the process determines a statistical distribution of keywords for each difficulty level; performs statistical analysis of the content (e.g., the INFOBIT) to determine the statistical distribution of keywords in the content; and assigns a difficulty level to the content by comparing the statistical distribution of keywords in the content with the statistical distribution of keywords in a document having a determined difficulty level.

The process begins by treating a general set of documents as a control set (Step 700). This set can be an arbitrary collection of documents concerning any subject area or originating with any source and can be used to determine the statistical distribution of words in use regardless of the difficulty of the content. This set serves as a base line or reference to be compared against documents of a particular difficulty level.

Next, a training set of documents is selected for each declared difficulty level {L1, L2, L3, L4, . . . Ln} (Step 704). This can either be done by human filtering or by automatic input. Each of the documents in the training set and in the control set is parsed and the statistics on word occurrence is obtained (Steps 708, 712). Keywords that have a statistically significant difference of occurrence between the control and training document sets is determined to be a classifier set W{Ln} for each level Ln (Step 716).

A given piece of content, such as a document, a document section, or an INFOBIT, is then parsed and words present in classifier sets W{L1, L2, . . . Ln} are counted (Step 720). The difficulty level of the content is established based on the mapping of the content's keywords distribution to the distribution in the training documents (Step 724).

### Content Organization and Storage

With content organized according to concept and, optionally, difficulty level, embodiments of the present invention can organize and store the content according to concept to facilitate its later consumption and use.

FIGS. 8-11 show diagrams of a method for organizing and storing content based on concepts contained in the content according to various embodiments of the invention. For example, some embodiments organize content according to its main concept and, in some embodiments, according to related concepts or the way that the primary concept relates to other concepts. For example, with reference to FIG. 8, the piece of content explains a concept, references a concept, tests a concept or is an example of a concept. Furthermore, items of content may be tagged with additional attributes that may be used in their organization, such as “difficulty level,” “age appropriateness,” “author,” “duration,” “date of creation,” and other parameters.

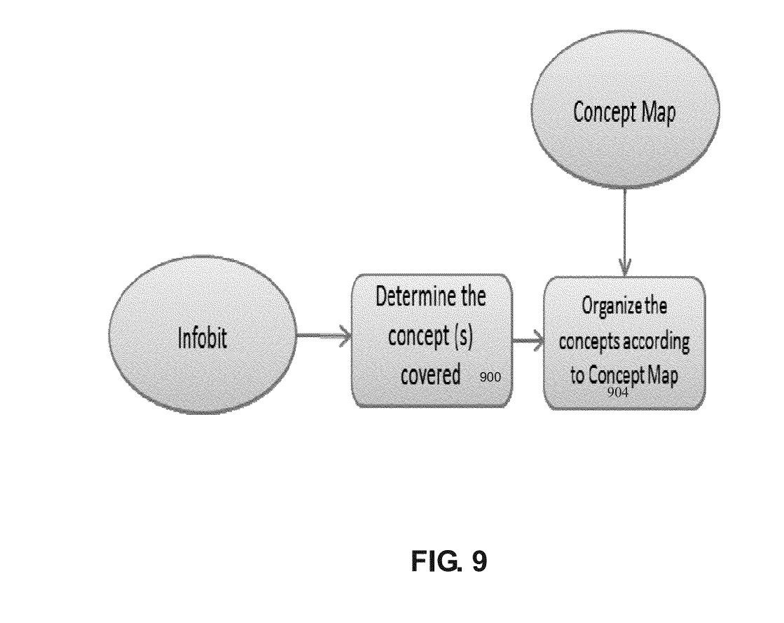

With reference to FIG. 9, the process begins by identifying the concepts associated with a particular piece of content, as discussed above (Step 900). The concepts are then organized in accordance with a pre-existing concept map (Step 904). Once organized, each item of content can be categorized (not shown) and the categorized content can be organized in accord with the concept map (not shown).

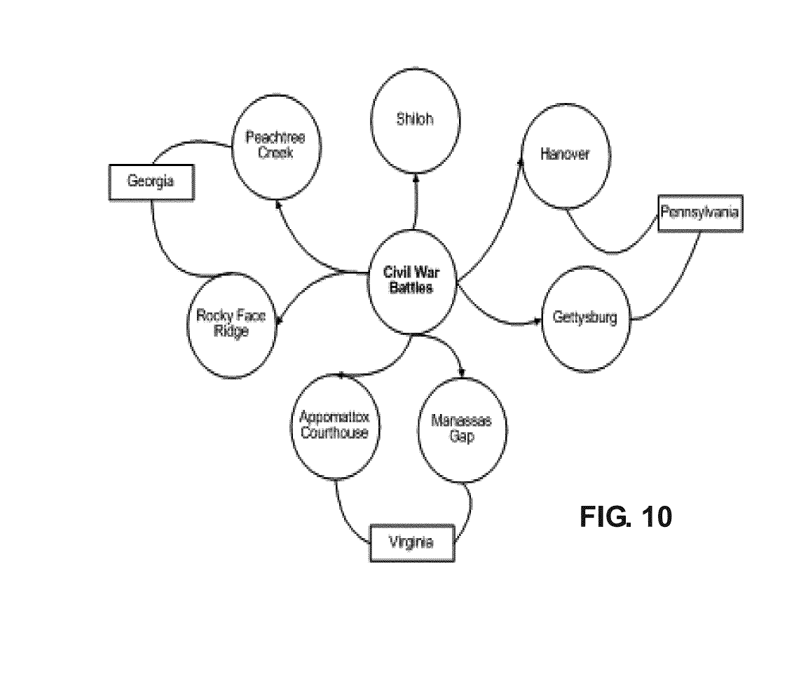

The concept map itself may be generated from a set of multiple concepts that are known to be related by virtue of another item of content, for example, an index found at the end of a textbook. The more often the concepts occur together in the same content, the stronger is their connection. These concepts are stored in a database and provide an organizational structure for the subsequent analysis of other pieces of content. An example of such a concept knowledge map showing linked educational materials from various resources according to subject area, difficulty, and grade level is presented in FIG. 10. Similarly to individual items of content. concepts themselves can also be assigned attributes such as their difficulty level and other parameters. Other embodiments of a concept map may include a list (ontology) of concepts, some of which may be related to each other; a taxonomy of linked categories; and/or a list of keywords (with weights) corresponding to each category and difficulty level. In one embodiment, an existent concept map may be expanded by analyzing keywords present in an lnfobit that has just been categorized and to which a difficulty level has been assigned. As is presented in FIG. 2, by analyzing a sequence of keywords which are present in a concept map, a relationship of the concepts corresponding to those keywords may be determined.

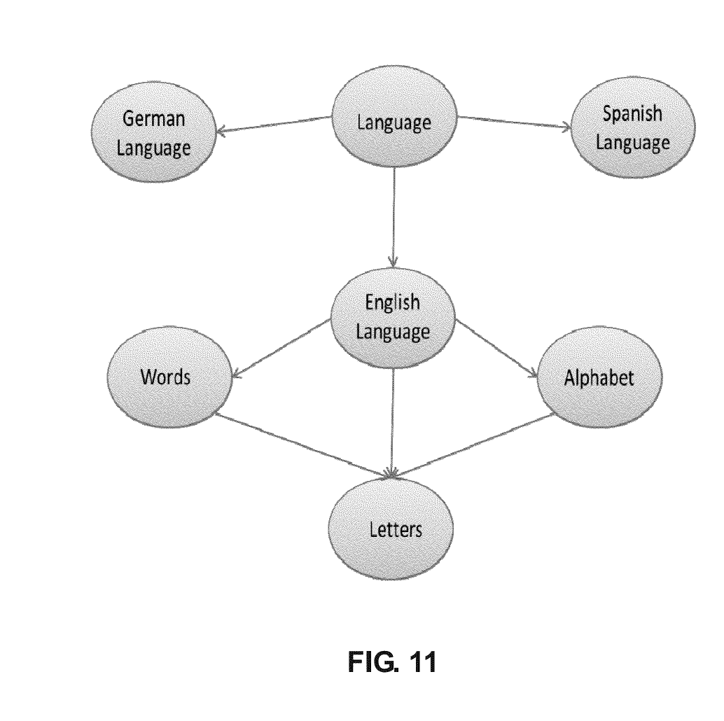

With reference to FIG. 11, the relationships between concepts in one field can be extrapolated to other areas. For example, the relationships among certain concepts for learning one foreign language can closely resemble the relationships among those or similar concepts for learning another language. This property can be implemented, e.g., using classes in an object oriented paradigm. For example. the subclasses for Spanish Language and German Language would be similar to those under English Language.

### Online Learning

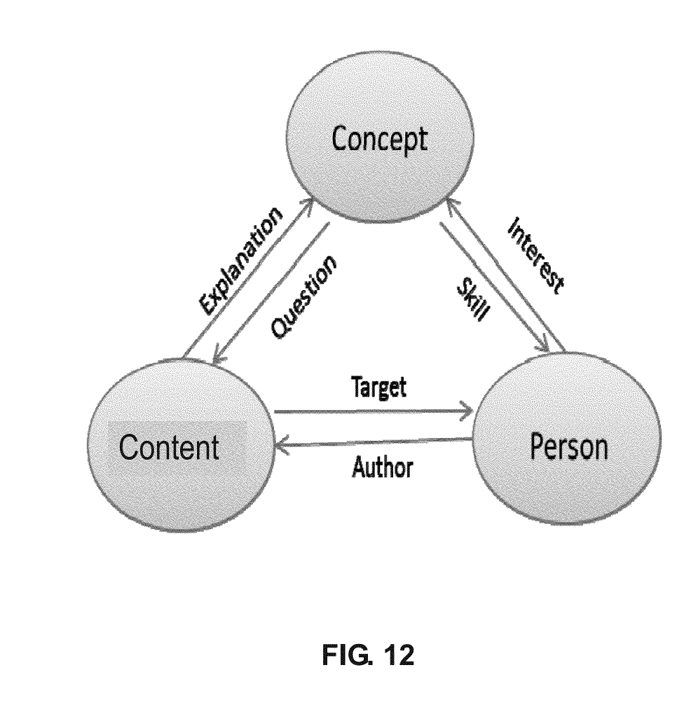

FIG. 12 shows a diagram of a method for organizing educational concepts for data-driven, automatic, concept-based online learning according to one embodiment of the invention.

This embodiment defines at least three classes of entities: Concepts, Content, and Persons. Each Content entity is related to Concept entities via a many-to-many relation. Content entities are hierarchical such that an individual Content entity may itself contain multiple Content entities. Concept entities are related to other Concept entities with relationships such as “prerequisite”, or “similarity”. Content entities and Concept entities are also related: a piece of content may “explain,” “reference,” “exemplify,” or “test” a set of concepts. A Person entity is related to a Content entity as follows: a person may be an “author” of a piece of content, and content may “target” a user or a set of users. A Person entity is related to a Concept entity as follows: each person has a certain “skill” level for a set of concepts. representing their mastery of that concept.

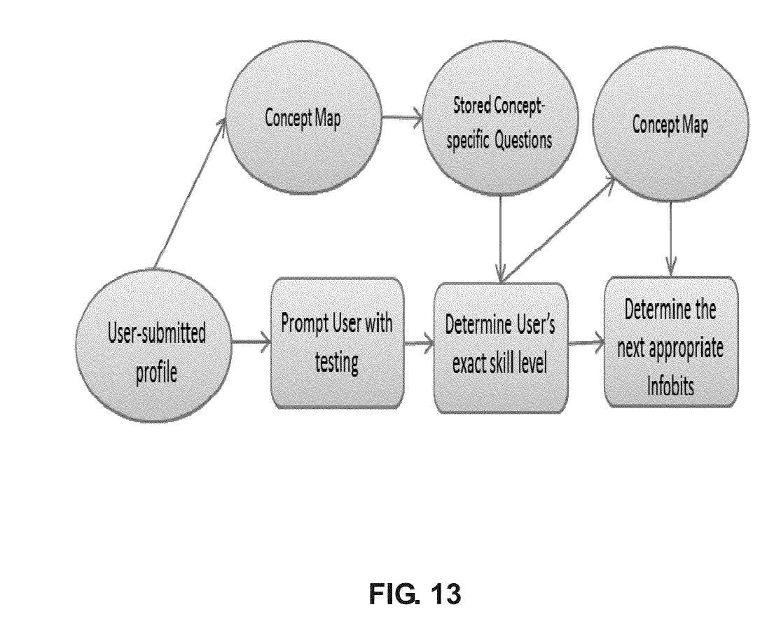

FIG. 13 shows a diagram of a method for selecting the most appropriate pedagogical information for a user according to one embodiment of the invention. The embodiment determines the user's skill level from user-submitted profile information or by testing the user's skill level with targeted questions. for example, testing on concept that the user claims to know. Once the person's knowledge state is determined for a subject area, embodiments of the present invention provide the user with a customized set of educational content that is in the same subject area at the next difficulty level or concerning a related concept.

The embodiment can also test the user's skill level using an adaptive test, where a correctly answered question is followed by a more difficult question in the same subject, and an incorrectly answered question is followed by an easier question. Incorrectly answered questions can also prompt a review lesson of the concept or the suggestion of pedagogical content related to that concept.

Tests themselves may also be Content entities, as discussed above, related to Concept entities via a “test” relationship and used to automatically assign a skill level to a Person-Concept pair.

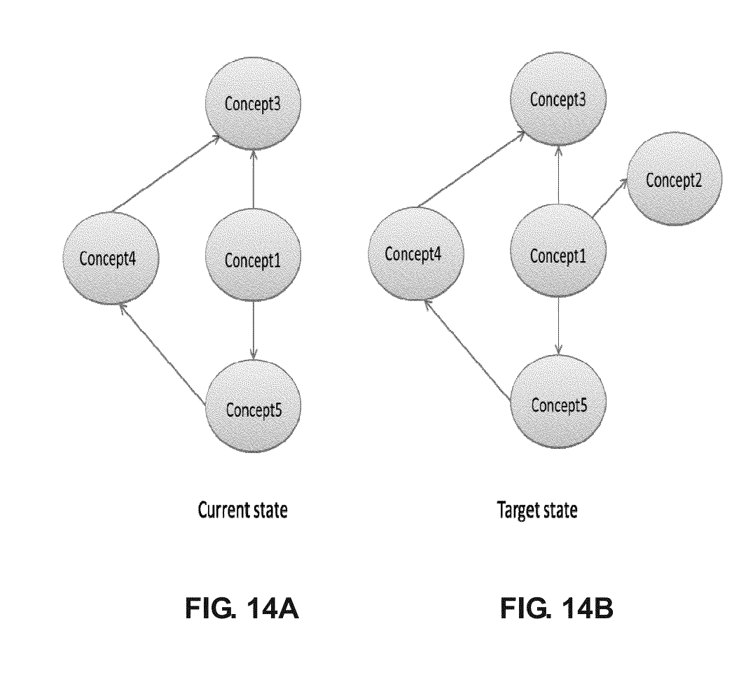

FIGS. 14A-B shows an example of a method for identifying instructional content for use with a particular user. A person's knowledge is represented as a concept map, with each concept associated with a certain skill level. Embodiments of the present invention suggest appropriate items of pedagogical content and courses based on the missing concepts and the complexity level relevant to the user.

Given the user's known current state of knowledge (FIG. 14A) and the target knowledge state that the user wants to acquire (FIG. 14B), the embodiment of the present invention determines that Concept2 is determined to be missing from user's knowledge base and therefore the user is offered items of content and courses that explain Concept2.

Embodiments of the present invention note when the user (e.g., a student) views a certain item of content. The user can be prompted to confirm his comprehension of the concept by taking a test and, if the test is successfully completed, the embodiment confirms the concept as known by the user. Further lessons are then suggested to the user based on the concepts and complexity levels that are determined to be part of the user's knowledge.

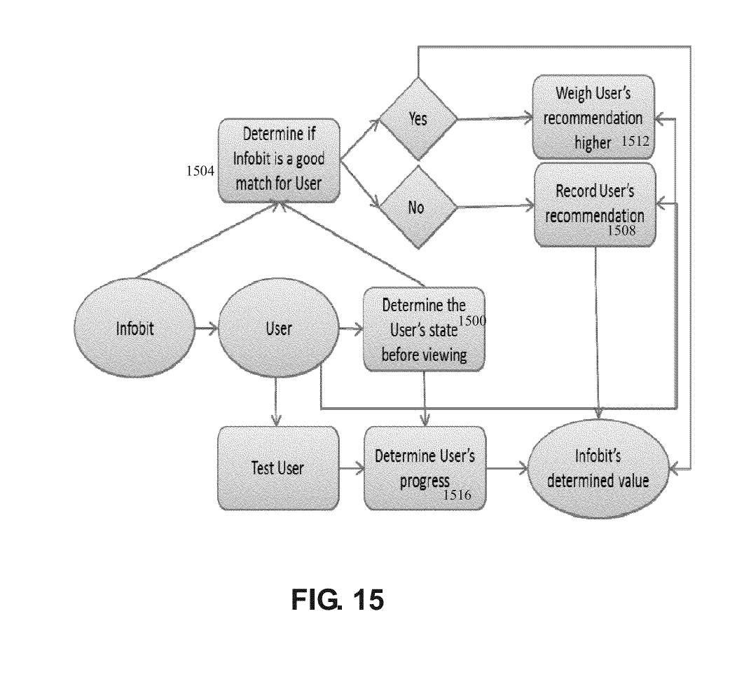

The embodiment of FIG. 15 determines the pedagogical value of a particular piece of content based on a user's test scores and ranking. The process begins by determining the user's knowledge prior to viewing the piece of content (Step 1500). After the concept and difficulty level of the piece of content are determined. the piece of content can be compared to the user's knowledge to determine if the content is a good match for the user (Step 1504). After the content is viewed, the user's recommendation and rating of the piece of content are collected (Step 1508) and the recommendations can be weighted higher if the user gives the piece of content a good rating (Step 1512).

The improvement of the user's knowledge can be determined following the viewing of the content by determining the state of the user's knowledge before and testing the user after viewing (Step 1516). A piece of content can be determined to be of higher pedagogical value if users consistently improve their knowledge following the viewing of that particular piece of content, and especially if that content is a good match for the users' skill level.

### Content Searching

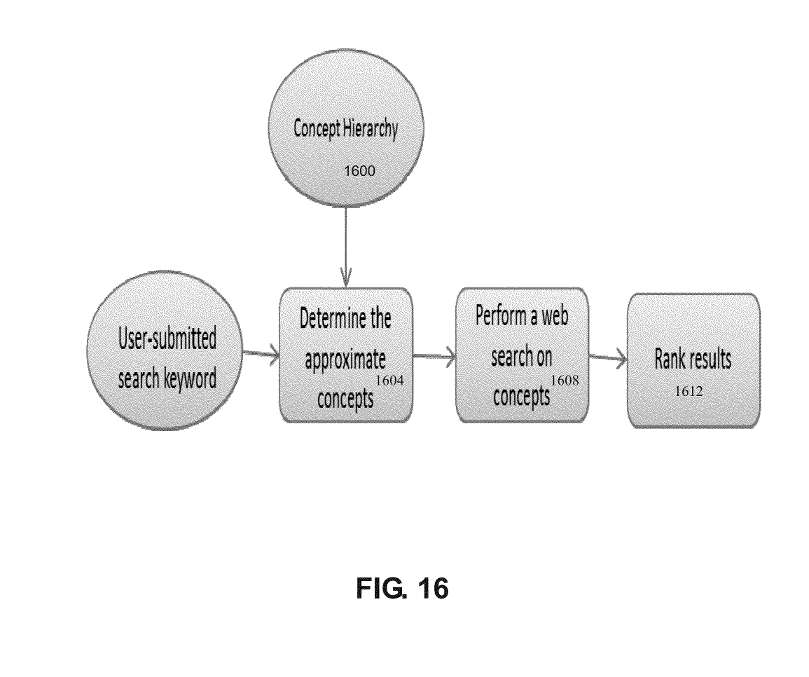

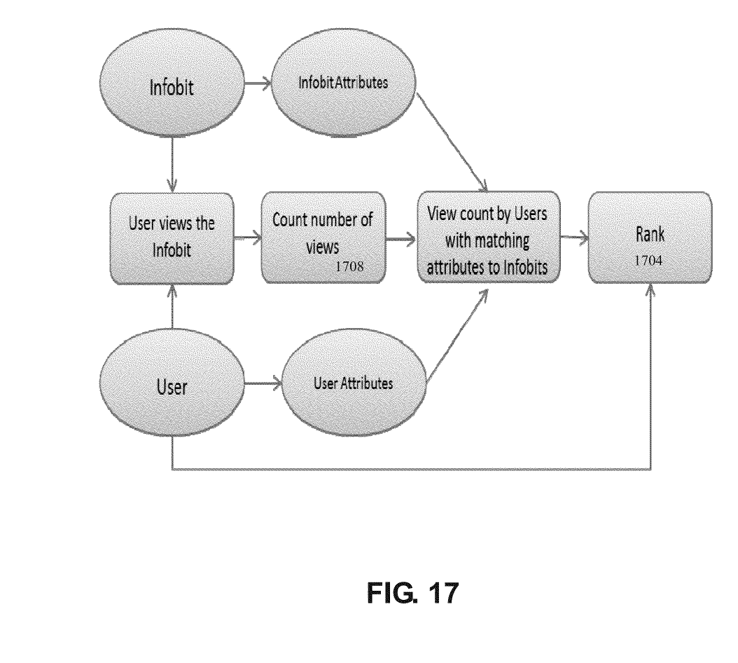

FIGS. 16 and 17 show how information from unrelated documents published on unrelated websites can be automatically clustered in a manner suitable for pedagogical objectives according to certain embodiments of the invention.

For example, one embodiment determines the hierarchical structure of web-search keywords and groups the findings of the web search according to that structure. The process begins with an index of concepts that are known to be related, such as an index from a textbook, an encyclopedia, a library, or any other pre-classified index (1600). As web search queries are received, the embodiment determines the portion of the index where the user's search keywords are found and utilizes the structure of the index in that portion to identify concepts related to those keywords (Step 1604). Having identified the related concepts, the embodiment then performs a web search on concepts that are closely related to the initial keyword set (Step 1608). The results of that search are then ranked, for example. based on how close the related search concepts are to the user's original search keywords, and provided to the user in that order (Step 1612).

FIG. 17 shows a diagram of a method for ranking content items based on quality and for promoting the best quality content to users according to one embodiment of the invention. The process is similar to that discussed above in connection with FIG. 16. However, all pieces of content may be ranked by users for, e.g., relevance to subject matter or concept as well as quality (was it engaging, interesting, etc.) and difficulty level (“too easy/difficult”; “too fast/slow”) (Step 1704). In addition to the user ranking, embodiments of the present invention also track the number of views of each piece of content (Step 1708).

This embodiment then ranks the content based on those user reviews and general view counts instead of the closeness of related concepts. In turn, higher-ranked content is presented more prominently to users, i.e., so that content that is more frequently viewed by users and/or better reviewed may be more prominently presented in searches for related concepts and difficulty levels. In certain embodiments, recommendations of particular items of content can be adjusted by the number of views the content has received by users whose profile and skill levels closely match the profile and skill levels of the content or the user performing the search.

Embodiments of the present disclosure. for example. are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed,

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

I claim:

1. A method for content management, the method comprising:
automatically organizing an electronic document into at least one item of subject-specific content;
automatically determining a concept associated with the at least one item of subject-specific content; and
organizing the at least one item of subject-specific content based on the at least one determined concept for the at least one item of subject-specific content.

2. The method of claim 1 further comprising automatically determining the difficulty level of the at least one item of subject-specific content by analyzing the occurrence of words in the at least one item of subject-specific content.

3. The method of claim 1 wherein the automatic determination of the concept for the at least one item of subject-specific content comprises comparing keyword statistics for the at least one item against pre-existing statistics for keywords derived from a control set of documents.

4. The method of claim 3 wherein the keywords derived from a control set of documents are organized in a concept map.

5. The method of claim 1 further comprising determining at least one related-concept keyword for the at least one item of subject-specific content.

6. The method of claim 1 wherein the electronic documents are retrieved from a pre-specified list of documents.

7. The method of claim 1 wherein the electronic documents are retrieved because they match at least one pre-specified keyword.

8. The method of claim 1 further comprising retrieving the electronic document through a network connection.

9. The method of claim 1 further comprising providing at least one item of subject-specific content to a user.

10. A system for content management. the system comprising:
a non-volatile memory; and
a processor, the processor configured to retrieve the at least one electronic document and store it in the non-volatile memory,
the processor further configured to automatically organize the retrieved document into at least one item of subject-specific content,
the processor further configured to automatically determining a concept associated with the at least one item of subject-specific content; and
the processor further configured to organize the at least one item of subject-specific content based on the at least one determined concept for the at least one item of subject-specific content.

11. The system of claim 10 wherein the processor is further configured to automatically determine the difficulty level of the at least one item of subject-specific content by analyzing the occurrence of words in the at least one item of subject-specific content.

12. The system of claim 10 wherein the processor is configured to automatically determine the concept for the at least one item of subject-specific content by comparing keyword statistics for the at least one item against pre-existing statistics for keywords derived from a control set of documents.

13. The system of claim 12 wherein the keywords derived from a control set of documents are organized in a concept map.

14. The system of claim 10 wherein the processor is further configured to determine at least one related-concept keyword for the at least one item of subject-specific content.

15. The system of claim 10 wherein the electronic documents are retrieved from a pre-specified list of documents stored in the non-volatile memory.

16. The system of claim 10 wherein the electronic documents are retrieved because they match at least one pre-specified keyword stored in the non-volatile memory.

17. The system of claim 10 further comprising a network interface for the transmission and retrieval of at least one electronic document.

18. The system of claim 10 further comprising an interface to deliver at least one item of subject-specific content to a user.
